(19) United States
(12) Patent Application Publication
(10) Pub. No.: US 2008/0310782 A1
(43) Pub. Date: Dec. 18, 2008

(54) Radial Bearing Having a Cassette Seal, and Cassette Seal

(75) Inventor: Wilhelm Walter, Poppenhausen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, HERZOGENAURACH (DE)

(21) Appl. No.: 12/158,349

(22) PCT Filed: Dec. 8, 2006
(86) PCT No.: PCT/DE2006/002186

§ 371 Date: Aug. 27, 2008

(30) Foreign Application Priority Data
Dec. 21, 2005 (DE) 10 2005 061 168.0

(51) Int. Cl. F16C 33/76; F16J 15/32

(52) U.S. Cl. 384/486; 277/402

(57) ABSTRACT

The invention relates to a radial bearing having a cassette seal, and to the cassette seal itself, in which the radial bearing has an inner ring, an outer ring, and rolling bodies which are arranged between them, and in which the cassette seal is arranged in a press fit axially next to the rolling bodies between the inner ring and the outer ring, wherein the cassette seal has a carrier, a seal which is fastened to it and a bent sheet-metal ring, against which sealing lips of the seal bear. For the inexpensive manufacture and the effective sealing of a radial bearing of this type, there is provision according to the invention for an additional means to the static seal to be arranged between the bent sheet-metal ring and the bearing ring.

### FIELD OF THE INVENTION

The invention relates to a radial bearing having a cassette seal, in which the radial bearing has an inner ring an outer ring and also rolling bodies arranged between them, and in which the cassette seal is arranged axially next to the rolling bodies between the inner ring and the outer ring in a press fit, the cassette seal having a carrier, a seal fastened thereto and a sheet-metal angle ring against which sealing lips of the seal bear. Moreover, the invention relates to a separately tradable cassette seal having said features.

### BACKGROUND OF THE INVENTION

Rolling bearings having cassette seals have been known for many decades. FIG. 5 illustrates, on a roiling bearing designed as an angular ball bearing 1, the bearing per se and also the cassette seal 10 inserted there into a press fit on the shaft and on the housing bore.

The angular ball bearing 1 consists essentially of an inner ring 2 and of an outer ring 3, between which, for example, rolling bodies designed as balls 4 are arranged moveably in raceways 8 and 9. The balls 4 are received in a cage 5 which is snapped on the inner ring 2 in an annular groove, not designated in any more detail.

To transmit axial forces between the inner ring 2 and the outer ring 3, rims 6 are formed on these two bearing rings.

To seal the rolling bearing 1, between the inner ring 2 and the outer ring 3 the cassette seal 10 is pressed in the press fit 27a on the inner ring 2 and in the press fit 27b on the outer ring 3, the press fit 27b being formed as an annular step 7 on the outer ring 3.

The cassette seal 10 consists essentially of a carrier 11 arranged on the outer ring and of an elastomeric seal 12 (elastomeric region) fastened to the carrier 11, with the result that a static seal is achieved there or in the region of the housing bore, and also of a sheet-metal angle ring 13 arranged on the inner ring, with the result that only a metallic press connection is achieved there or in the region of the shaft.

The sheet-metal angle ring 13 serves as a running surface for two lips of the seal 12.

The three components carrier 1, seal 12, and sheet-metal angle ring 13 have been assembled, before mounting between the inner ring 2 and the outer ring 3, to form said cassette seal 10.

Such a known combination of a rolling bearing 1 and cassette seal 10 must be produced with special care in order to prevent particles and moisture from penetrating into the rolling bearing. Particular attention must in this case be given to the dimensionally accurate production of the sheet-metal angle ring 13 which must sit (27a) as positively as possible on the radial surface of the rim 6 of the inner ring 2.

Such a sheet-metal angle ring 13 is usually produced nowadays in a deep-drawing operation.

If an undesirably pronounced deviation exists between the geometry of the bearing inner ring 2 and the sheet-metal angle ring 13 on the press fit 27a, it may happen, when such a bearing 1 is in operation, that, on account of pressure differences in the bearing 1, moisture enters the latter and may lead there to corrosion and ultimately to premature bearing failure.

In order to avoid such operational damage, the radial surfaces at the (metallic) press fit 27a of the bearing inner ring 2 and of the sheet-metal angle ring 13 are manufactured with great care and with low tolerances, thus incurring considerable costs.

### OBJECT OF THE INVENTION

The object on which the invention is based therefore, is to propose a radial bearing having a cassette seal, which, while having at least the same sealing action, can be produced more cost-effectively than known generic devices. This radial bearing having a cassette seal is also to be usable as a wheel bearing for motor vehicles.

### SUMMARY OF THE INVENTION

The invention is based on the realization that, in the region of (metallic) press connection, as here, according to the configuration of the cassette seal, for example, on the inner ring or on the shaft, an additional statically acting sealing of the radial bearing in the region of the cassette seal can improve the sealing action of the latter in such a way that the bearing ring rim and/or the sheet-metal angle ring can be produced cost-effectively because of reduced geometric accuracy requirements.

The invention therefore relates, first, to a radial bearing having a cassette seal, in which the radial bearing has an inner ring and an outer ring and also rolling bodies arranged between them, and in which the cassette seal is arranged axially next to the rolling bodies between the inner ring and the outer ring in a press fit, the cassette seal having a carrier, a seal fastened thereto and a sheet-metal angle ring against which sealing lips of the seal bear.

Moreover, according to the invention, there is provision for an (additional) sealing means to be arranged between the sheet-metal angle ring and the bearing ring, in particular, according to a corresponding configuration of a cassette seal, here the bearing inner ring.

This additional sealing means therefore acts as a static sealing means, since it has only contact with components of the bearing and sealing cassette which do not rotate in relation to one another, as in the case of the bearing ring and the sheet-metal angle ring arranged there by means of a press fit.

Even if, further on, in particular, additional static sealing by the additional sealing means on the inner ring is described here, this is also included correspondingly in the case of additional sealing by the additional sealing means on the outer ring, as regards a press fit of the sheet-metal angle ring there, and is the subject of the invention.

Even in the case of a sheet-metal angle ring or bearing ring rim being produced less exactly in geometric terms and therefore more cost-effectively, this static sealing reliably prevents the ingress of moisture into the bearing, for example if pressure differences occur in the bearing.

The sealing means is preferably arranged in an annular radial step in the bearing ring cooperating with the sheet-metal angle ring, in which case, depending on the design of the cassette seal, this bearing ring may be the bearing inner ring or the bearing outer ring, preferably the bearing inner ring.

In a further refinement of the invention, there is provision for the seal to have at least one sealing lip, in particular a sealing lip additional to the above-mentioned sealing lips, which in the bearing points essentially radially inward to the axis of rotation of the bearing and preferably bears against a radial surface of a bearing ring, in particular of the bearing inner ring, and/or against the end face of an axial leg of the sheet-metal angle ring.

According to another development of the invention, there is provision for the sealing lip pointing radially inward and lying on the bearing ring, in particular on the bearing inner ring, to have a smaller diameter D1 than the inside diameter D2 of the axial leg of the sheet-metal angle ring.

According to another feature, the sealing lip lying on the bearing ring has a smaller diameter D1 than the diameter D2 of the press fit of this bearing ring.

Preferably, the sealing means which is in contact only with components not rotating in relation to one another is formed by a radial end of the sealing lip, said radial end being separated when the cassette seal is pressed into the radial bearing. By virtue of this feature of the invention, a separate production of a relevant sealing means and a separate mounting of the latter on the bearing may advantageously be dispensed with.

According to a further refinement of the invention, the seal is of three-lip design, with the additional sealing lip described, with a second sealing lip bearing against the inside of a radial leg of the sheet-metal angle ring, and with a third sealing lip bearing against the inside of the axial leg of the sheet-metal angle ring.

To achieve an even further improved sealing action of the cassette seal according to the invention, it is also possible that a further sealing lip, in particular an elastomeric sealing lip, and/or for static sealing on the housing, is arranged on the carrier and bears radially against the assigned bearing ring, in particular against the bearing outer ring (3) (elastomeric region).

Moreover, there is preferably provision for said annular step for receiving the additional sealing means formed from the separated radial end of the first sealing lip to have a ratio of radial height H to axial width B in the region of 0.05 to 1 or 0.1 to 1 or 0.02 to 1, but, in particular, 0.15 to 1.

It may be noted, moreover, that the bearing ring, mentioned several times, on which the annular step is formed, is designed as an inner ring or as an outer ring, particularly preferably as a bearing inner ring.

However, which of the two bearing rings is provided with the annular step depends essentially on the geometric design of the cassette seal, in particular on the radial direction in which the first sealing lip is oriented with its separable free end in the cassette seal or in the bearing.

Finally, the invention relates to a cassette seal as an independently produceable and tradable unit, which is characterized by a carrier, a seal fastened to the carrier, a sealing lip formed on the seal and a sheet-metal angle ring, the sealing lip pointing essentially radially inward and having a diameter D1 which is smaller than the inside diameter D2 of an axial leg of the sheet-metal angle ring, and also not lying radially on this axial leg. Preferably, this sealing lip bears against the end face of the axial leg of the sheet-metal angle ring. Moreover, in the mounted state, this sealing lip bears on the radial surface of a bearing ring of the radial bearing.

### BRIEF DESCRIPTION OF THE DRAWINGS

The invention is explained in more detail below by means of some embodiments with reference to the accompanying drawings in which:

FIG. 1 shows a schematic cross-sectional illustration of an angular ball bearing with a cassette seal according to the invention,

FIG. 2 shows the cassette seal according to FIG. 1, illustrated as a detail,

FIG. 3 shows the inner ring of the angular ball bearing according to FIG. 1 before assembly with the cassette seal according to FIG. 2,

FIG. 4 shows the cassette seal before assembly with the inner ring, and

FIG. 5 shows an angular ball bearing having a cassette seal according to the prior art.

### DETAILED DESCRIPTION OF THE DRAWINGS

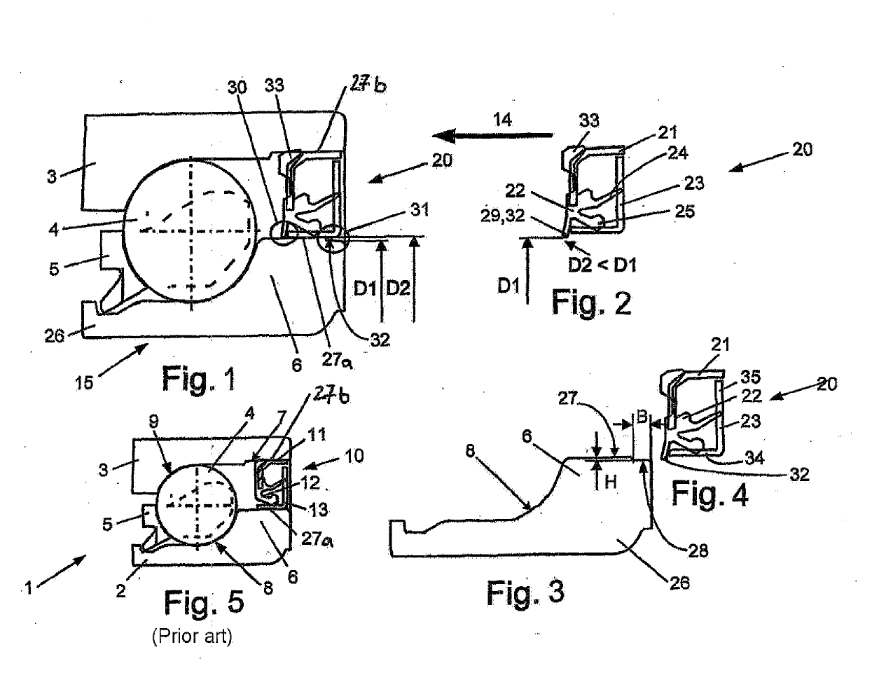

FIG. 1 shows, accordingly, a radial bearing 15 which is designed as an angular ball bearing and which is constructed essentially in the same way as the radial bearing 1 according to FIG. 5, known per se and described initially. In this radial bearing 15, therefore, balls 4 are received in a cage 5 and are arranged rotatably between an inner ring 26 and an outer ring 3. The inner ring 26 has a rim 6 which serves for receiving a cassette seal 20 (by means of a press fit 27a).

As, in particular, FIGS. 2 and 4 make clear, this cassette seal 20 has a carrier 21 for a seal 22 which is fastened thereto and which here is of three-lip design. The cassette seal 20 also includes a sheet-metal angle ring 23, by means of which the cassette seal 20 is fastened to the inner ring 26 by means of the press fit 27a.

The sheet-metal angle ring 23 has an axial leg 34 and a radial leg 35, against whose insides, pointing toward the seal 22, the sealing lips 24 and 25 bear. The free end of the radial leg 35 points toward an axially oriented portion of the carrier 21, between which an axial gap, not designated in any more detail is formed, said axially oriented portion of the carrier 21 being arranged on the outer ring 3 by means of the press fit 27b.

An elastomeric sealing lip 33, of comparatively thick design at its radial end, of the seal 22 is arranged on the axially other side of the carrier 21 and is supported radially on the outer ring 3 and forms a static sealing with respect to the housing (elastomeric region).

Of particular importance in connection with the invention, then, is the sealing lip 29 which points radially in the direction of the inner ring 26 and which has a radial end 32. The sealing lip 29 has a diameter D1 which is smaller than the inside diameter D2 of the axial leg 34 of the sheet-metal angle ring 23 or of the press fit 27a of the inner ring 26.

Moreover, for the action of the radial bearing 15, there is also provision for the inner ring 26 to have an annular step 28 at that end of its rim 6 which is remote from the rolling bodies (FIG. 3). This step is of comparatively small design and has a ratio of its radial height H to its axial width B of 0.05 to 1 or 0.1 to 1 or 0.02 to 1, but, in particular, of 0.15 to 1. The inside diameter of this step 28 is preferably identical to the diameter of the sealing lip 29.

As a comparison of FIGS. 3 and 4 makes clear, the diameter D1 of the radial end 32 of the sealing lip 29, the diameter of the axial leg 34 of the sheet-metal angle ring 23 and the height H or the inside diameter of the annular step 28 on the inner ring 26 are coordinated with one another such that, when the cassette seal 20 is introduced into the reception region between the inner ring 26 and the outer ring 3 according to the arrow 14, the radial end 32 of the sealing lip 29 is received, initially unharmed, in the annular step 28.

Since the sealing lip 29 bears with its radial end 32 against the free end face of the axial leg 34 of the sheet-metal angle ring 23, when the cassette seal 20 is introduced or pressed in further between the inner ring 26 and the outer ring 3 of the bearing 15 this radial end 32 is separated by the axial leg 34 of the sheet-metal angle ring 23 and remains as (additional) static sealing means 32 in the annular sealing gap formed by the inner ring 26 and the axial leg 34 of the sheet-metal angle ring 23. Reference is made, in this respect, to the details 30 and 32 in FIG. 1.

The cooperation of the said structural features of the radial bearing 15 and the cassette seal 20 leads to a highly effectively sealed radial bearing which, in terms of its individual parts and its mounting, can be produced cost-effectively, for example as a wheel bearing for motor vehicles.

Finally, the invention also relates to the cassette seal 20 per se, which may be a product which a bearing manufacturer can procure as a delivery part from another manufacturer. This cassette seal 20 has, in particular, a carrier 21, a seal 22 fastened to the carrier 21 and having a sealing lip 29, and a sheet-metal angle ring 23, the sealing lip 29 pointing essentially radially inward in the direction of the reception orifice for a bearing ring 26 and having a diameter D1 which is smaller than the inside diameter D2 of an axial leg 34 of the sheet-metal angle ring 23. The sealing lip 29 in this case does not lie on the axial leg 34, but preferably bears against its end face.

### REFERENCE SYMBOLS

1 Radial bearing, angular ball bearing
2 Inner ring
3 Outer ring
4 Rolling body, ball
5 Cage
6 Rim on the inner ring
7 Step on the outer ring
8 Rolling body raceway
9 Rolling body raceway
10 Cassette seal
11 Carrier
12 Seal
13 Sheet-metal angle ring
14 Arrow, mounting direction
15 Radial bearing with cassette seal according to the invention
20 Cassette seal
21 Carrier
22 Seal
23 Sheet-metal angle ring
24 Sealing lip
25 Sealing lip
26 Inner ring
27a Press fit on the inner ring or in the region of the shaft
27b Press fit on the outer ring or in the region of the housing
28 Annular step
29 Sealing lip (for additional static sealing)
30 Detail
31 Detail
32 Radial end of the sealing lip 29; sealing means
33 Static sealing, elastomeric region
34 Axial leg of the sheet-metal angle ring
35 Radial leg of the sheet-metal angle ring
B Width of the step
H Height of the step
D1 Diameter of the sealing lip 29; inside diameter of the step 28
D2 Diameter of the press fit; inside diameter of the sheet-metal angle ring

1. A radial bearing comprising: an inner ring an outer ring and rolling bodies arranged between them, a cassette seal is arranged axially next to the rolling bodies between the inner ring and the outer ring in a press fit, the cassette seal having a carrier, a seal fastened thereto and a sheet-metal angle ring against which sealing lips of the seal bear, and a sealing means is arranged between the sheet-metal angle ring and the bearing ring.

2. The radial bearing as claimed in claim 1, wherein the sealing means is arranged in an annular radial step in the bearing ring, said step cooperating with the sheet-metal angle ring.

3. The radial bearing as claimed in claim 1, wherein the seal has at least one sealing lip.

4. The radial bearing as claimed in claim 3, wherein the sealing lip in the cassette seal points essentially radially inward and lies on the bearing ring, in particular the bearing inner ring, and/or bears against the end face of an axial leg of the sheet-metal angle ring.

5. The radial bearing as claimed in claim 3, wherein the sealing lip has a smaller diameter than the inside diameter of the axial leg of the sheet-metal angle ring.

6. The radial bearing as claimed in claim 3, wherein the sealing lip has a smaller diameter than the diameter of the press fit of the bearing ring.

7. The radial bearing as claimed in claim 1, wherein the sealing means is formed by a radial end of the sealing lip, said radial end being separated when the cassette seal is mounted into the radial bearing.

8. The radial bearing as claimed in claim 1, wherein the seal is of three-lip design, with the sealing lip, with a sealing lip bearing against the inside of a radial leg of the sheet-metal angle ring, and with a sealing lip bearing against the inside of the axial leg of the sheet-metal angle ring.

9. The radial bearing as claimed in claim 1, wherein a further sealing lip is arranged on the carrier and bears radially against the assigned bearing ring.

10. The radial bearing as claimed in claim 1, wherein the annular step has a ratio of radial height to axial width in the region of 0.05 to 1 or 0.1 to 1 or 0.02 to 1, or 0.15 to 1.

11. The radial bearing as claimed in claim 1, wherein the bearing ring is designed as an inner ring or as outer ring.

12. A cassette seal for a radial bearing, comprising: a carrier, a seal fastened to the carrier, a sealing lip formed on the seal and a sheet-metal annular ring, the sealing lip pointing essentially radially inward and having a diameter which is smaller than the inside diameter of an axial leg of the sheet-metal angle ring, and not lying radially on the axial leg.
